(19) United States
(12) Patent Application Publication
(10) Pub. No.: US 2014/0192086 A1
(43) Pub. Date: Jul. 10, 2014

(54) CAMERA-BASED DEVICE AND METHOD OF AUGMENTING DATA DISPLAYED ON A DISPLAY DEVICE USING THE CAMERA-BASED DEVICE

(71) Applicant: SAMSUNG ELECTRONICS CO., LTD., Suwon-si (KR)

(72) Inventors: Muthukumar SUBRAMANIAN, Tamilnadu (IN); Annapoorani KANAGARAJ, Tamilnadu (IN)

(73) Assignee: SAMSUNG ELECTRONICS CO., LTD., Suwon-si (KR)

(21) Appl. No.: 14/149,063

(22) Filed: Jan. 7, 2014

(30) Foreign Application Priority Data
Jan. 7, 2013 (IN) 57/CHE/2013
Nov. 6, 2013 (KR) 10-2013-0134376

(51) Int. Cl. G06T 11/60; G06F 3/01

(52) U.S. Cl. CPC G06T 11/60; G06F 3/017
USPC 345/633

(57) ABSTRACT

A method of augmenting data that is displayed on a display device by using a camera-based device, and the camera-based device are provided. The method includes configuring a network setting of the camera-based device to enable communication between the camera-based device and the display device; performing calibration to capture an initial boundary in the display device; capturing data that is displayed on the display device; associating the captured data with additional data; and displaying the additional data on the display device. The camera-based device includes a communication interface; and a processor that configures a network setting to enable communication between the camera-based device and the display device, perform calibration in order to capture an initial boundary in the display device; capture data that is displayed on the display device, associate the captured data with additional data; and display the additional data on the display device.

### RELATED APPLICATIONS

This application claims priority from Indian Patent Application No. 57/CHE/2013, filed on Jan. 7, 2013, in the Indian Patent Office and Korean Patent Application No. 10-2013-0134376, filed on Nov. 6, 2013, in the Korean Intellectual Property Office, the disclosures of which are incorporated herein by reference, in their entirety.

### BACKGROUND

1. Technical Field

One or more exemplary embodiments relate to a camera-based device and a method of augmenting data that is displayed on a display device by using the camera-based device.

2. Description of the Related Art

Recently developed in the display areaand formed as one body with a mobile device, is very small, mobile device technology which is being employed to display data on a display device. As an example, a mobile device is configured to display data, for example, a PowerPoint presentation, on a display device. The PowerPoint presentation may be stored in a memory of the mobile device. The PowerPoint presentation may be presented to one or more users, for example, in a seminar. The PowerPoint presentation may be stored in each of the user's mobile device. The display device may be configured to receive a PowerPoint presentation, and operate to present the PowerPoint presentation to the users.

During a seminar, in response to a user desiring to share additional data with other users, the user may need to execute one or more editing operations on the PowerPoint presentation. Through the one or more editing operations, data is augmented. A PowerPoint presentation, on which the one or more editing operations are performed, may be displayed on the display device, so that user may together view the PowerPoint presentation and the additional data. However, it takes a lot of time to perform editing operations on a PowerPoint presentation in order to augment data.

Accordingly, there is a demand for an effective method and system for augmenting data that is to be displayed on a display device.

### SUMMARY

One or more exemplary embodiments include a camera-based device and a method of augmenting data that is displayed on a display device by using the camera-based device.

Additional aspects will be set forth in p in the description which follows and, in part, will be apparent from the description, or may be learned by practice of the exemplary embodiments.

According to one or more exemplary embodiments, a method of augmenting data that is displayed on a display device by using a camera-based device, includes configuring a network setting of the camera-based device to enable communication between the camera-based device and the display device; performing calibration to capture an initial boundary in the display device; capturing data that is displayed on the display device; associating the captured data with additional data; and displaying the additional data on the display device.

According to one or more exemplary embodiments, a camera-based device for augmenting data that is displayed on a display device includes a communication interface to establish communication between the camera-based device and the display device; a memory for storing instructions; and a processor that, in response to the instructions, configures a network setting to enable communication between the camera-based device and the display device; performs calibration to capture an initial boundary in the display device; captures data that is displayed on the display device; associates the captured data with additional data; and displays the additional data on the display device.

An aspect of an exemplary embodiment may provide a camera-based device for augmenting data that is displayed on a display device, the camera-based device including: a communication interface configured to establish communication between the camera-based device and the display device; and a processor configured to access stored instructions and establish a network setting to enable communication between the camera-based device and the display device, wherein the processor is configured to perform calibration in order to capture an initial boundary in the display device; capture data that is displayed on the display device and associate the captured data with additional data, and wherein the processor is configured to calculate a gesture boundary that corresponds to a gesture associated with the camera-based device, according to the initial boundary, in response to accessing the stored instructions.

The camera-based device may further include a memory for storing the instructions.

The processor may be configured to display the additional data on the display device.

The processor may be further configured to determine the gesture associated with the camera-based device, based on a position of the gesture boundary in response to accessing the stored instructions.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a block diagram of an environment according to an exemplary embodiment;

FIG. 2 is a block diagram of a camera-based device for augmenting data that is displayed on a display device, according to an exemplary embodiment;

FIG. 3 is a block diagram of a module that operates on a processor included in the display device, according to an exemplary embodiment;

FIG. 4 is a block diagram of a module that operates on a processor included in the camera-based device, according to an exemplary embodiment;

FIG. 5 is a flowchart of a method of augmenting data that is displayed on the display device according to an exemplary embodiment; and

FIGS. 6A through 6D illustrate augmenting data that is displayed on the display device, according to an exemplary embodiment.

### DETAILED DESCRIPTION OF THE EXEMPLARY EMBODIMENTS

Reference will now be made in detail to exemplary embodiments, examples of which are illustrated in the accompanying drawings, wherein like reference numerals refer to like elements throughout. In this regard, the exemplary embodiments may have different forms and should not be construed as being limited to the descriptions set forth herein. Accordingly, the exemplary embodiments are merely described below, by referring to the figures, to explain aspects of the description. As used herein, the term “and/or” includes any and all combinations of one or more of the associated listed items. Expressions such as “at least one of,” when preceding a list of elements, modify the entire list of elements and do not modify the individual elements of the list.

It may be understood that operational steps and system components are provided by using symbols of the related art in the drawings, representing only specific details which are relevant for an understanding of exemplary embodiments. Furthermore, for purposes of clarity, details that are readily apparent to one of ordinary skill in the art may not be described herein. In exemplary embodiments, relational terms, such as “first,” “second,” and the like, may be used to distinguish one entity from another entity, without necessarily implying any actual relationship or order between such entities.

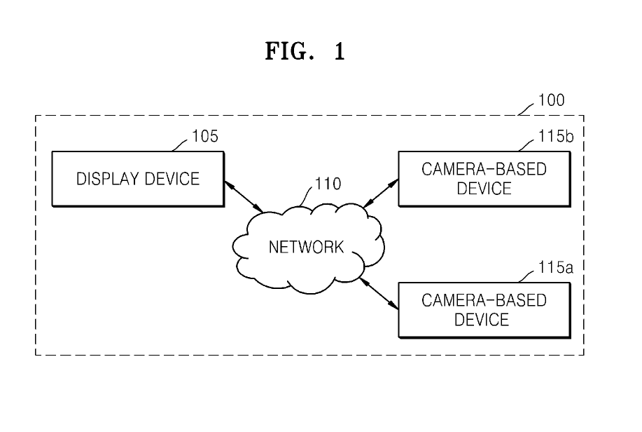

FIG. 1 is a block diagram of an environment 100 according to an exemplary embodiment. The environment 100 includes a display device 105, a network 110, and one or more camera-based devices, for example, a camera-based device 115a and a camera-based device 115b.

The display device 105 includes an electronic device that operates to display data. Examples of the display device 105 may include a TV, a mobile phone, a computer, a laptop computer, a portable device, a personal digital assistant (PDA), a tablet personal computer (PC), and a communication device, but are not limited thereto.

The camera-based device 115a includes an electronic device having a built-in camera. The camera-based device 115a may operate to capture data that is displayed on the display device 105. Examples of the camera-based device 115a may include a mobile phone having a built-in camera, a digital camera, a PDA, a webcam, or other electronic devices having a built-in camera, but are not limited thereto.

The camera-based device 115a and the camera-based device 115b are connected to the display device 105 via the network 110. Examples of the network 110 may include a wireless network, a local area network (LAN), and a wide area network (WAN), but are not limited thereto.

The camera-based device 115a configures a plurality of network settings. A network setting enables communication between the camera-based device 115a and the display device 105.

In response to the network setting being configured, the camera-based device 115a may perform calibration for capturing an initial boundary in the display device 105. The calibration is performed to locate data within the initial boundary that is captured by the camera-based device 115a.

Additionally, the data, displayed on the display device 105, is captured by the camera-based device 115a so that the displayed data may be augmented. Augmentation of the data includes associating the displayed data with additional data, and through the associating, a user may obtain improved knowledge related to the displayed data.

In response to the data, displayed on the display device 105, being captured, the captured data and the additional data are associated with each other, and thus, augmented data is generated.

Additionally, the additional data may be displayed on the display device 105 via the camera-based device 115a. Accordingly, the displayed additional data may improve data that is displayed on the display device 105.

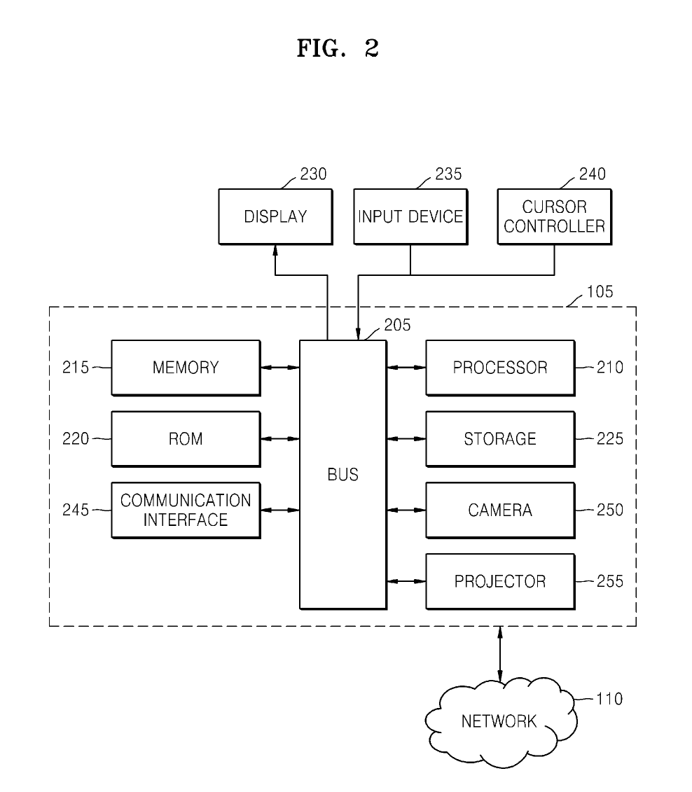

A block diagram of the camera-based device 115a, which includes a plurality of components that enable augmentation of data that is displayed on the display device 105, is described in detail, with reference to FIG. 2.

FIG. 2 is a block diagram of the camera-based device 115a for augmenting data that is displayed on the display device 105, according to an exemplary embodiment.

The camera-based device 115a includes a bus 205 for information communication, and a processor 210 that is connected to the bus 205. The processor 210 processes one or more commands transmitted by the camera-based device 115a. The camera-based device 115a also includes a memory 215 that is connected to the bus 205, for example, random access memory (RAM) and stores one or more instructions which is processed by the processor 210. The memory 215 may be used to store temporary information that is required by the processor 210. The camera-based device 115a further includes read-only memory (ROM) 220 that is connected to the bus 205 and stores static information required by the processor 210. A storage 225, for example, a magnetic disk, a hard disk, or an optical disk, may be provided, and thus connected to the bus 205 so as to store information, for example, data captured by the camera-based device 115a.

The camera-based device 115a may be connected via the bus 205 to a display 230, for example, a cathode ray tube (CRT) display, a liquid crystal display (LCD), a plasma display, or the like, so as to display data. An input device 235, which includes various keys, is connected to the bus 205 so as to transmit a command to the processor 210. In some embodiments, a cursor controller 240, for example, a mouse, a trackball, a joystick, or cursor direction keys for transmitting a command to the processor 210 and controlling cursor movement on the display 230, may also be present.

According an exemplary embodiment, the camera-based device 115a performs operational steps by using the processor 210. An instruction may be read from a machine-readable medium, for example, the storage 225 into the memory 215. According to another exemplary embodiment, a hard-wired circuitry may be used in place of or in combination with software instructions to implement various exemplary embodiments. The term, “machine-readable medium” may be defined as a medium for providing data to a machine so that the machine may perform a particular function. The machine-readable medium may be a storage medium. A storage medium may include a non-volatile medium or a volatile medium. All such media need to be tangible so that a physical mechanism that reads an instruction into a machine may detect an instruction carried by the media.

Examples of the machine-readable medium may include a floppy disk, a flexible disk, a hard disk, a magnetic tape, a CD-ROM, an optical disk, a punch card, a paper tape, RAM, programmable read-only memory (PROM), erasable programmable read-only memory (EPROM), or flash-EPROM, but are not limited thereto.

The camera-based device 115a also includes a communication interface 245 connected to the bus 205. The communication interface 245 enables data communication. Examples of the communication interface 245 may include an integrated services digital network (ISDN) card, a modem, a LAN card, an infrared port, a Bluetooth® port, a ZigBee® port, and a wireless port, but are not limited thereto.

In some exemplary embodiments, the processor 210 may include one or more processing units that perform one or more functions of the processor 210. The one or more processing units are hardware circuits for performing a particular function.

The processor 210, included in the camera-based device 115a, may operate to configure a plurality of network settings so as to enable communication. Communication may be enabled between the camera-based device 115a and the display device 105.

The processor 210 is configured to enable calibration for capturing an initial boundary in the display device 105. A camera 250, included in the camera-based device 115a, may be used to capture an initial boundary in the display device 105. Calibration is performed to accommodate a boundary in the display device 105 on a display of the camera-based device 115, and locate data within the captured initial boundary.

In addition to the initial boundary, the processor 210 is also configured to capture a gesture boundary that corresponds to a gesture associated with the camera-based device 115a. A gesture boundary is captured so that data and additional data are located in the gesture boundary that corresponds to the gesture associated with the camera-based device 115a.

In response to the gesture boundary being captured, the processor 210 may operate in order to determine a gesture associated with the camera-based device 115a, based on a position of the gesture boundary. A gesture may include a movement of the camera-based-device 115a in a right, left, upward, or downward direction with respect to a position of the display device 105. A gesture may also include rotation of the camera-based device 115a in a clockwise direction or a counterclockwise direction with respect to the display device 105.

The processor 210 may operate to capture data that is displayed on the display device 105. Examples of data may include an image, text, and video data, but are not limited thereto. The camera 250, included in the camera-based device 115a, is used to capture data.

The processor 210 is configured to associate the captured data with additional data, so as to generate augmented data. Data may be augmented by associating captured data with additional data. Examples of additional data may include an image, text, audio data, and video data, but are not limited thereto. According to an exemplary embodiment, text may be converted into audio data by using one or more text-audio converters. Additional data may be also referred to as value-added information which corresponds to data. Data improvement can be accomplished by augmented data that is generated by associating the additional data with the captured data.

Additionally, the processor 210 may operate to visually display additional data on the display device 105. The additional data may be located on the display device 105, based on the gesture that is associated with the camera-based device 115a. The additional data may be displayed according to a display command that is transmitted to the display device 105 by the camera-based device 115a. Upon receiving the display command, the display device 105 displays the additional data.

According to another exemplary embodiment, additional data may be projected on the display device 105. The additional data may be projected on the display device 105 by using a projector 255 that is included in the camera-based device 115a. As the additional data is projected, the data that is displayed on the display device 105 may be augmented.

As the augmented data is displayed, the augmented data may be presented to one or more users. The one or more users may obtain information that is improved in association with the augmented data.

The processor 210 may operate to locate the augmented data on the display device 105, based on a gesture that is associated with the camera-based device 115a. The processor 210 is configured to transmit one or more gesture-based commands to the display device 105. The one or more gesture-based commands are received by the display device 105 via the communication interface 245. The display device 105 may operate to locate the augmented data in response to the one or more gesture-based commands.

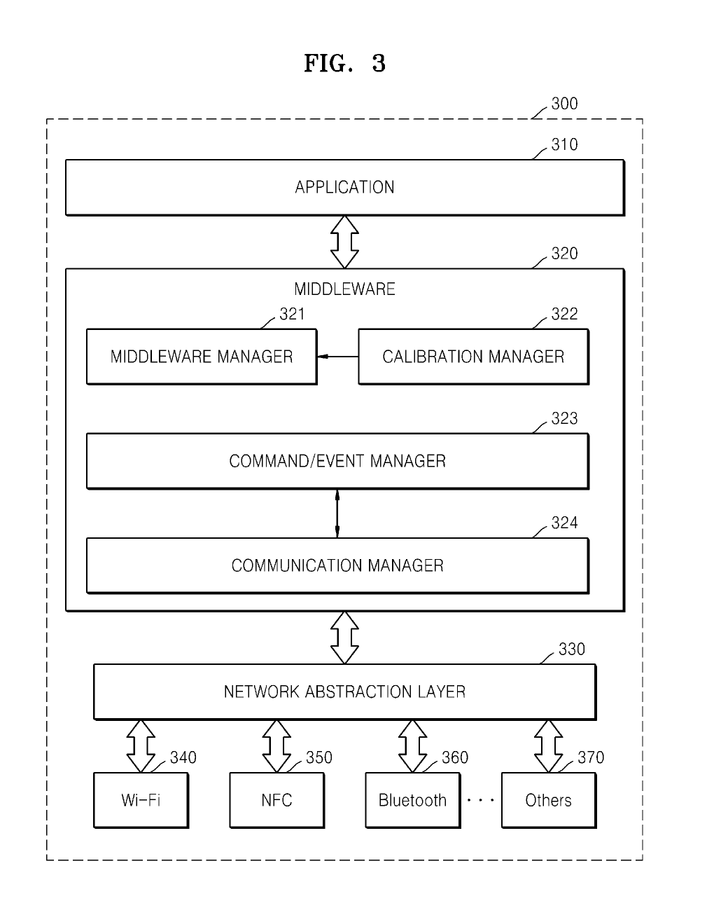

FIG. 3 is a block diagram of a module 300 that operates on a processor included in the display device 105, according to an exemplary embodiment.

Referring to FIG. 3, a network abstraction layer 330 is preconfigured by using Wi-Fi 340, near field communication (NFC) 350, Bluetooth® 360, or another network 370, and used to communicate with a camera-based device.

Middleware 320 includes a communication manager 324 that constitutes a network and communication protocol, a calibration manager 322 that performs a calibration process such as generation of a unique pattern that may be used for the camera-based device to identify an initial boundary, a command/event manager 323 that transmits a command/event for performing an appropriate operation, and a middleware manager 321 that manages the managers 322 through 324.

An application 310 shows a unique pattern that may be identified by the camera-based device prior to the start of communications, and performs an appropriate operation on a currently-displayed object.

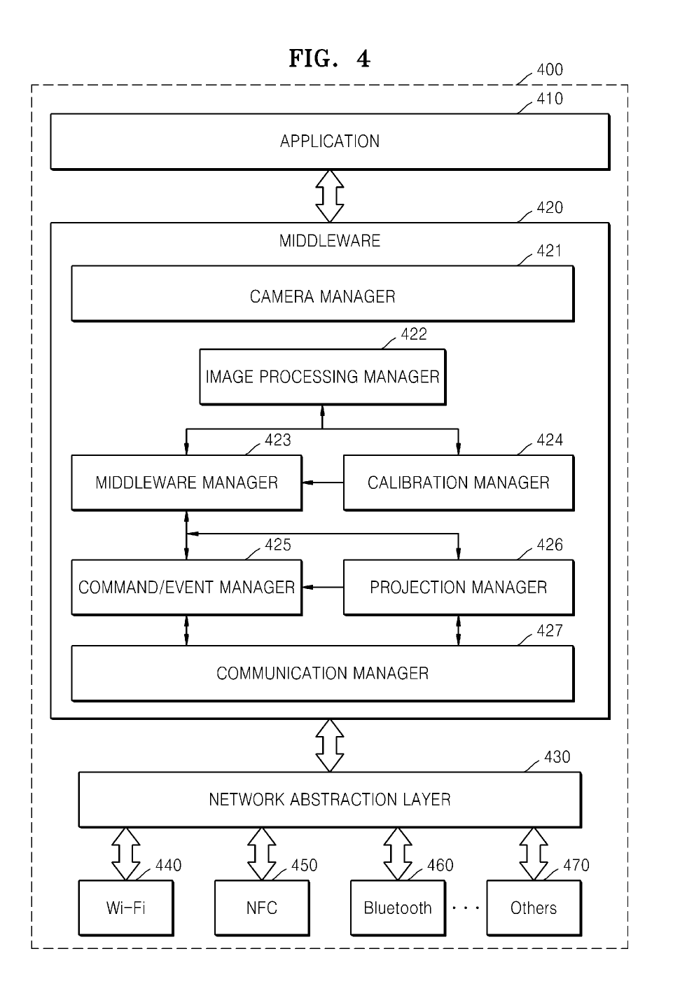

FIG. 4 is a block diagram of a module 400 that operates on the processor 210 included in the camera-based device, according to an exemplary embodiment.

Referring to FIG. 4, a network abstraction layer 430 is preconfigured by using Wi-Fi 440, NFC 450, Bluetooth® 460, or another network 470, and is used to communicate with the display device 105.

Middleware 420 includes a communication manager 427 that constitutes a network and communication protocol, a calibration manager 424 that performs a calibration process and stores an initial boundary, a command/event manager 425 that transceives a command/event with the display device 105, an image processing manager 422 that processes data that is captured from the display device 105, and additional data for augmenting the captured data, a projection manager 426 that processes additional data so that the additional data is projected on the display device 105, and a camera manager 421 that captures data that is displayed on the display device 105.

An application 410 displays an output from a camera, performs calibration, and determines a gesture boundary, in collaboration with the camera manager 421.

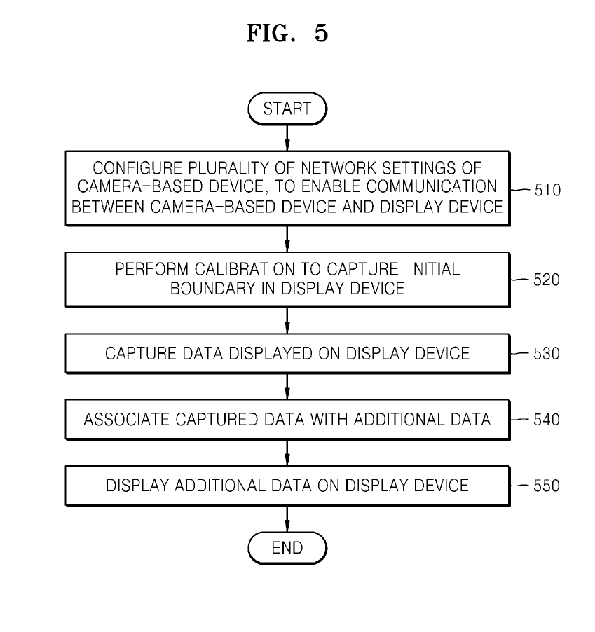

A method of augmenting data that is displayed on the display device 105 is described with reference to FIG. 5.

FIG. 5 is a flowchart of a method of augmenting data that is displayed on a display device, according to an exemplary embodiment.

In operation 510, a plurality of network settings are configured by using a camera-based device, for example, the camera-based device 115a. Examples of the camera-based device may include a mobile phone having a camera, a digital camera, a webcam, and other electronic devices having a built-in camera, but are not limited thereto. The plurality of network settings are configured to enable communication between the camera-based device and a display device, for example, the display device 105. Examples of the display device may include a TV, a mobile phone, a computer, a laptop computer, a portable device, a PDA, and a communication device, but are not limited thereto. The display device is used to display data. Examples of data may include an image, text, or video data, but are not limited thereto.

One or more communication protocols may be used to enable communication. In response to communication already being established between the camera-based device and the display device, based on the configuration of the plurality of network settings, the display device may detect the camera-based device.

In operation 520, the camera-based device enables calibration for capturing an initial boundary in the display device. The calibration is performed to accommodate a boundary in the display device within a display area of the camera-based device 115, and locate data within the captured initial boundary.

In response to the calibration being completed, a position of the initial boundary on the display area of the camera-based device is fixed. According to an exemplary embodiment, scaling is performed to perform calibration. One or more scaling technologies may be used to perform calibration.

In operation 530, data, displayed on the displace device, is captured by the camera-based device. The capturing is performed so that the data may be augmented. The augmenting of the data includes associating the data that is displayed on the display device with additional data, and based on the association, a user may obtain improved knowledge regarding the displayed data. A camera, included in the camera-based device, is used to capture data.

Capturing of data is performed to calculate a gesture boundary that corresponds to a gesture associated with the camera-based device. A gesture may include a movement of the camera-based-device in a right, left, upward, or downward direction with respect to the display device. A gesture may also include rotation of the camera-based device in a clockwise direction or a counterclockwise direction with respect to the display device.

A gesture boundary is calculated so that the captured data is located in the gesture boundary that corresponds to a gesture.

In response to the gesture boundary being calculated, a gesture that is associated with the gesture boundary is determined.

In correspondence with the determined gesture, data is located on the display device. The locating of the data in correspondence with the determined gesture is performed based on a plurality of gesture commands that are transmitted by the camera-based device to the display device. The plurality of gesture commands may be transmitted by using one or more communication protocols, for example, a wireless protocol.

In operation 540, additional data and data that was captured in operation 530, are associated with each other, and thus augmented data is generated. The additional data is associated with data in real time. According to an exemplary embodiment, the additional data may include value-added data that corresponds to the data that was captured in operation 530. Examples of data may include an image, text, or video data, but are not limited thereto.

Augmented data provides information that is improved in association with the data provided to a user. The additional data may be stored in a cloud or a memory of the camera-based device.

The associating of the additional data with the data that was captured in operation 530 is performed by visually displaying the additional data on the display device.

In operation 550, the additional data is visually displayed on the display device, so that one or more users may view the captured data and the additional data together. According to an exemplary embodiment, as a display command is transmitted to the display device, the additional data is displayed on the display device. The display command is transmitted by using a communication protocol, for example, a wireless protocol. According to another exemplary embodiment, additional data is projected, and thus displayed on the display device.

Additionally, the displayed additional data may be located on the display device 105, in correspondence with the determined gesture. The locating of the displayed additional data on the display device in correspondence with the determined gesture is performed based on a plurality of gesture commands that are transmitted to the display device by the camera-based device. The plurality of gesture commands may be transmitted by using a communication protocol.

By displaying the additional data, the data that is displayed on the display device is augmented. Additionally, based on the additional data that includes value-added information, a user may obtain detailed knowledge regarding the data. Additionally, since the additional data is displayed by transmitting a display command to the display device 105 or projecting the additional data on the display device, a user does not need to perform editing that takes a lot of time to display the additional data.

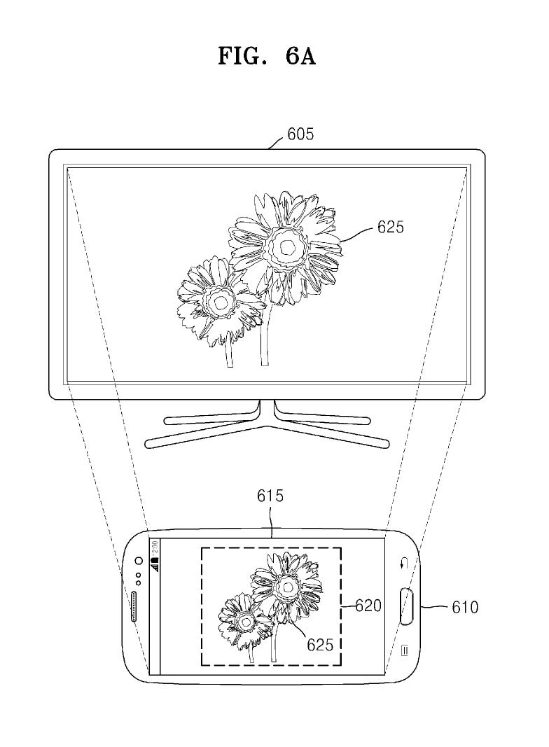

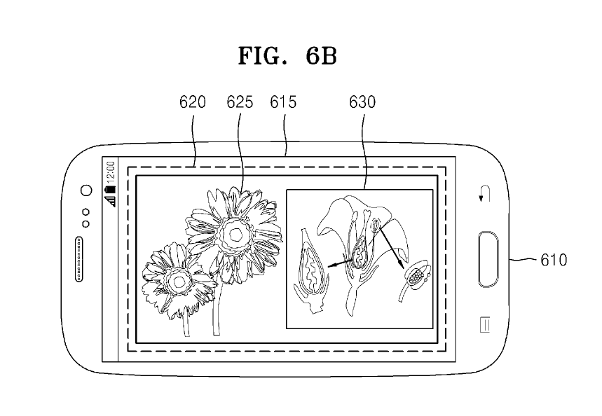

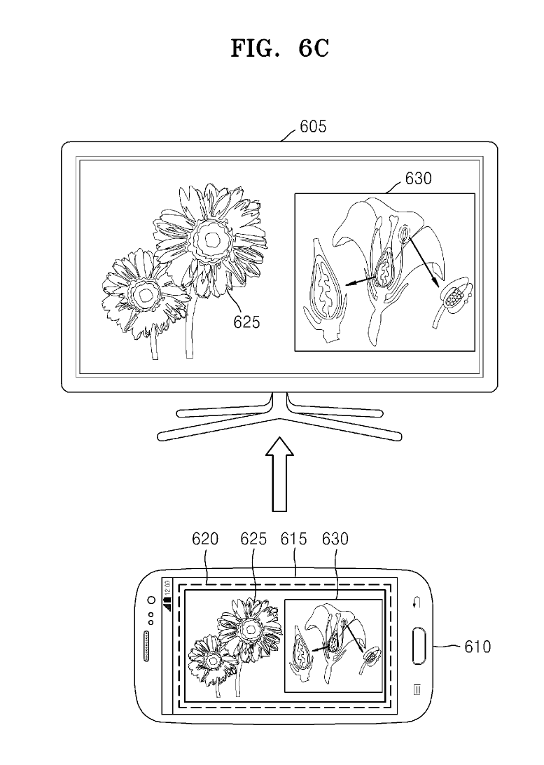

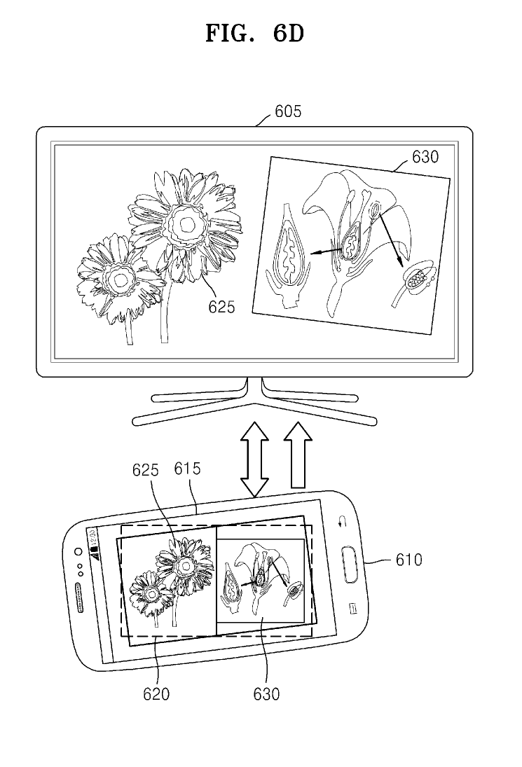

FIGS. 6A through 6D illustrate augmenting data that is displayed on a display device, according to an exemplary embodiment. FIGS. 6A through 6D illustrate a display device 605 and a mobile device 610. According to an exemplary embodiment, the display device 605 may be a TV. The mobile device 610 is configured to include a camera and data 625 that is displayed on the display device 605. Additionally, the display device 605 and the mobile device 610 are configured to communicate with each other.

The mobile device 610 configures a plurality of network settings to enable communication between the display device 605 and the mobile device 610. One or more communication protocols may be used to enable the communication.

The mobile device 610 performs calibration to capture an initial boundary 615 in the display device 605. The calibration is performed to accommodate a boundary in the display device 605 within a display area of the mobile device 610. Additionally, the calibration may locate the data 625 within the captured initial boundary 615. According to an exemplary embodiment, the mobile device 610 performs calibration by employing scaling. In response to the calibration being performed, a position of the initial boundary 615 on the display area of the camera-based device is fixed.

Additionally, as shown in FIG. 6A, the data 625 that is displayed on the display device 605 is captured by the mobile device 610.

The mobile device 610 calculates a gesture boundary. As an example of the gesture boundary, a dashed rectangle 620 is shown in FIG. 6A. The gesture boundary is calculated with respect to the initial boundary. A gesture that is associated with the mobile device 610 is determined based on a position of the gesture boundary. A position of the dashed rectangle 620 is changed, based on movement of the mobile device 610 with respect to the initial boundary 615.

Referring to FIG. 6B, additional data 630 and the data 625 are associated with each other, and thus augmented data is generated. According to an exemplary embodiment, the additional data 630 may include information that enables a user to obtain detailed knowledge regarding the data 625. The additional data 630, stored in a memory of the mobile device 610, may also be generated by using one or more input devices such as a stylus or a touch input. The additional data 630 may be stored in a cloud or the memory of the mobile device 610. The mobile device 610 is configured to browse the additional data 630 in the cloud or the memory of the mobile device 610, before generating augmented data, by associating the additional data 630 with the data 625.

Referring to FIG. 6C, the additional data 630 is visually displayed on the display device 605, and thus, one or more users may view the data 625 and the additional data 630 together.

According to an exemplary embodiment, the mobile device 610 displays the additional data 630 on the display device 605, by transmitting a display command to the display device 605. The display command is transmitted to the display device 605 by using a communication protocol, for example, a wireless protocol.

According to another exemplary embodiment, the additional data 630 is projected, and thus, the additional data is displayed on the display device 605. As shown in FIG. 6C, a projector that is included in the mobile device 610 is used to project the additional data 630 on the display device 605.

Referring to FIG. 6D, the mobile device 610 is rotated in a clockwise direction with respect to a position of the display device 605. In response to the mobile device 610 being rotated in a clockwise direction, the data 625 and the additional data 620 that are displayed on the mobile device 610 are also rotated in a clockwise direction in correspondence with the rotating of the mobile device 610. Accordingly, as shown in FIG. 6D, the mobile device 610 calculates a gesture boundary, by rotating the dashed rectangle 620 in a clockwise direction with respect to the initial boundary 615. The gesture boundary is calculated to accommodate the data 625 and the additional data 630 in response to the mobile device 610 being rotated in a counterclockwise direction.

Additionally, the mobile device 610 determines a gesture. In an exemplary embodiment, a gesture indicates rotation of the mobile device 610 in a clockwise direction. Similarly, various gestures, such as movement of the mobile device 610 in a left, right, upward, or downward direction or rotation of the mobile device 610 in a counterclockwise direction, may be determined.

Additionally, in response to the gesture being determined, the mobile device 610 may locate the data 625 and the additional data 630 on the display device 605 in a clockwise direction that corresponds to rotation of the mobile device 610.

According to an exemplary embodiment, the mobile device 610 may transmit a gesture-based command, for example, a command of rotating in a clockwise direction, and thus locate the data 625 and the additional data 630 on the display device 605 in a clockwise direction. When the gesture-based command is received, as shown in FIG. 6D, the data 625 and the additional data 630 are located on the display device 605 in a counterclockwise direction.

Similarly, various gesture-based commands that correspond to various gestures may be transmitted to the display device 605 to locate the data 625 and the additional data 630 on the display device 605.

As described above, according to the one or more of the above exemplary embodiments, a method of augmenting data by associating data with additional data that includes value-added information and a camera-based device are provided. According to an exemplary embodiment, a user may obtain detailed knowledge regarding the data from the value-added information. Additionally, by displaying the additional data on a display device by transmitting a display command to or by projecting the additional data on the display device, a user does not need to perform editing that takes a lot of time to display the additional data. Additionally, by projecting the data on the display device, a user may change a game setting, for example, a user name, in real time. Additionally, the method may be applied to an arbitrary electronic device that includes hardware at a minimum. For example, the method may be implemented by using an electronic device that includes a camera or a projector.

In addition, other exemplary embodiments can also be implemented through computer-readable code/instructions in/on a medium, e.g., a computer-readable medium, to control at least one processing element to implement any above described exemplary embodiment. The medium can correspond to any medium/media permitting the storage and/or transmission of the computer-readable code.

The computer-readable code can be recorded/transferred on a medium in a variety of ways, with examples of the medium including recording media, such as magnetic storage media (e.g., ROM, floppy disks, hard disks, etc.) and optical recording media (e.g., CD-ROMs or DVDs), and transmission media such as Internet transmission media. Thus, the medium may be such a defined and measurable structure including or carrying a signal or information, such as a device carrying a bitstream according to one or more exemplary embodiments. The media may also be a distributed network, so that the computer-readable code is stored/transferred and executed in a distributed fashion. Furthermore, the processing element could include a processor or a computer processor, and processing elements may be distributed and/or included in a single device

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope of the present invention as defined by the following claims.

What is claimed is:

1. A method of using a camera device to augment data that is displayed on a display device, the method comprising:
configuring a network setting of the camera-based device to enable communication between the camera-based device and the display device;
performing calibration to capture an initial boundary in the display device;
capturing data that is displayed on the display device;
associating the captured data with additional data; and
displaying the additional data on the display device.

2. The method of claim 1, further comprising calculating a gesture boundary that corresponds to a gesture associated with the camera-based device, according to the initial boundary.

3. The method of claim 2, further comprising determining the gesture associated with the camera-based device, based on a position of the gesture boundary.

4. The method of claim 1, further comprising locating at least one of the displayed data and the additional data on the display device, based on a gesture associated with the camera-based device.

5. The method of claim 1, wherein the displaying of the additional data is performed by transmitting a display command to the display device or projecting the additional data to the display device.

6. A camera-based device for augmenting data that is displayed on a display device, the camera-based device comprising:
a communication interface configured to establish communication between the camera-based device and the display device;
a memory for storing instructions; and
a processor that accesses the stored instructions,
wherein the processor, in response to the accessing the stored instructions, is configured to
establish a network setting to enable communication between the camera-based device and the display device;
perform calibration in order to capture an initial boundary in the display device;
capture data that is displayed on the display device;
associate the captured data with additional data, and
display the additional data on the display device.

7. The camera-based device of claim 6, wherein the processor is configured to calculate a gesture boundary that corresponds to a gesture associated with the camera-based device, according to the initial boundary, in response to accessing the stored instructions.

8. The camera-based device of claim 7, wherein the processor is configured to determine the gesture associated with the camera-based device, based on a position of the gesture boundary, in response to accessing the stored instructions.

9. The camera-based device of claim 6, wherein the processor is configured to locate at least one of the displayed data and the additional data on the display device, based on a gesture associated with the camera-based device in response to accessing the stored instructions.

10. The camera-based device of claim 6, wherein the displaying of the additional data is performed by transmitting a display command to the display device or projecting the additional data to the display device.

11. A non-transitory computer-readable storage medium having stored thereon a computer program, which when executed by a processor of a computer, causes the computer to use a camera-based device to perform a method of augmenting data that is displayed on a display device, the method comprising:
configuring a network setting of the camera-based device to enable communication between the camera-based device and the display device;
performing calibration to capture an initial boundary in the display device;
capturing data that is displayed on the display device;
associating the captured data with additional data; and
displaying the additional data on the display device.

12. A camera-based device for augmenting data that is displayed on a display device, the camera-based device comprising:
a communication interface configured to establish communication between the camera-based device and the display device; and
a processor configured to access stored instructions and establish a network setting to enable communication between the camera-based device and the display device,
wherein the processor is configured to perform calibration in order to capture an initial boundary in the display device; capture data that is displayed on the display device and associate the captured data with additional data, and
wherein the processor is configured to calculate a gesture boundary that corresponds to a gesture associated with the camera-based device, according to the initial boundary, in response to accessing the stored instructions.

13. The camera-based device of claim 12, further comprising a memory for storing the instructions.

14. The camera-based device of claim 12, wherein the processor is configured to display the additional data on the display device.

15. The camera-based device of claim 12, wherein the processor is configured to determine the gesture associated with the camera-based device, based on a position of the gesture boundary in response to accessing the stored instructions.
